(19) United States
(12) Patent Application Publication
(10) Pub. No.: US 2011/0268334 A1
(43) Pub. Date: Nov. 3, 2011

(54) Apparatus for Improving Image Resolution and Apparatus for Super-Resolution Photography Using Wobble Motion and Point Spread Function (PSF), in Positron Emission Tomography

(75) Inventors: Jong Beom Ra, Daejeon (KR); Kye Young Jeong, Busan (KR); Woo Hyun Nam, Busan (KR); Ji Hye Kim, Gyeonggi-do (KR)

(73) Assignee: Korean Advanced Institute of Science and Technology, Daejeon (KR)

(21) Appl. No.: 13/097,727

(22) Filed: Apr. 29, 2011

(30) Foreign Application Priority Data
Apr. 30, 2010 (KR) 10-2010-0040823
Apr. 30, 2010 (KR) 10-2010-0040842
Mar. 8, 2011 (KR) 10-2011-0020495
Mar. 8, 2011 (KR) 10-2011-0020506

(51) Int. Cl. G06K 9/00

(52) U.S. Cl. 382/131

(57) ABSTRACT

Provided are an apparatus and method for improving image resolution in a positron emission tomography (PET), which may reconstruct a high-resolution image in a PET system using a motion of an entire detector or a bed motion and may maintain a characteristic of a sinograms using a positive number in a sinogram computing, by applying a super-resolution algorithm that may be based on a maximum likelihood expectation maximization (MLEM) algorithm.

### CROSS-REFERENCE TO RELATED APPLICATIONS

This application claims the benefit of Korean Patent Application Nos. 10-2010-0040823, filed on Apr. 30, 2010, 10-2010-0040842, filed on Apr. 30, 2010, 10-2011-0020495, filed on Mar. 8, 2011, and 10-2011-0020506, filed on Mar. 8, 2011 in the Korean Intellectual Property Office, the disclosures of which are incorporated herein by reference.

### BACKGROUND

1. Field of the Invention

The present invention relates to an apparatus for improving image resolution in a positron emission tomography (PET), and more particularly, to an apparatus for a super-resolution photography use a wobble motion and a point spread function (PSF) in the PET image, that may generate a PET image using a super-resolution technique. The apparatus for the super-resolution photography will be hereinafter referred to as an ‘apparatus for generating an image.’

2. Description of the Related Art

A widely used positron emission tomography (PET) is a nuclear medicine examination practice that may indicate, using a three-dimensional (3D) image, a physiological, chemical, and functional image with respect to a human body, using radioactive medicine that may irradiate a positron.

The PET is commonly used to diagnose various types of cancers, and may provide helpful results with respect to a differential diagnosis of a cancer with respect to stage progression, recurrence evaluation, judgment on remedial effectiveness, and the like.

Furthermore, a receptor image or a metabolic image for assessment with respect to a heart disease, a brain disease, and a brain function may be obtained using the PET.

A positron irradiated from a radioactive isotope may consume all self kinetic energy during an extremely short time after being irradiated, and may then be combined with a neighboring electron and may be annihilated. In this instance, the positron may irradiate two annihilated radioactive rays, that is, gamma rays at an angle of 180°.

A cylindrical PET scanner may detect two annihilated radioactive rays that may be simultaneously irradiated. When an image is reconstructed using the detected radioactive rays, how much and in which part of the body radioactive medicine is gathered may be indicated using a 3D tomographic image.

### SUMMARY

According to an aspect of the present invention, there is provided an apparatus for improving resolution, including a response ray detector to detect response rays in response to radioactive rays irradiated to a measurement target, a sinogram extractor to extract sinograms from the detected response rays, and a super-resolution converter to convert the extracted sinograms into high-resolution sinograms.

The high-resolution converter may extract, from the detected response rays, a plurality of sinograms, at least parts of which may be overlapped, and may convert the plurality of the extracted sinograms into high-resolution sinograms.

The high-resolution converter may convert the plurality of the extracted sinograms into the high-resolution sinograms, using a super-resolution algorithm. The extracted sinograms may remain in a blur state by at least one factor among a positron range of the radioactive rays, non-colinearity of the radioactive rays, and a size of a detector.

The apparatus for improving resolution may further include an image reconstruction processing unit to reconstruct a high-resolution image from the converted high-resolution sinograms, and the image reconstruction processing unit may use at least one of a filtered back projection (FBP) algorithm, a back projection and filtering (BPF) algorithm, a total-variation regularization algorithm, an ordered-subset expectation maximization (OSEM) algorithm with respect to a Poisson distribution, and a maximum a priori expectation maximization (MAP-EM) algorithm with respect to a Poisson distribution.

The high-resolution converter may estimate a blur kernel of a positron emission tomography (PET) image based on information that may be measured in a PET detector, and may convert the extracted sinograms into high-resolution sinograms using the measured blur kernel.

The high-resolution converter may estimate the high-resolution sinograms, based on at least one of low-resolution sinograms that may be measured in at least one wobble position, information indicating a relationship between the high-resolution sinograms and the low-resolution sinograms, a noise component that may enable the measured low-resolution sinograms to be a random vector having a Poisson distribution.

The high-resolution converter may estimate the relationship between the high-resolution sinograms and the low-resolution sinograms, based on at least one of movement information of sinograms in the at least one wobble position, information indicating down-sampling, information indicating a blur between the high-resolution sinograms and low-resolution sinograms.

In a case of a spatially variant blur, the high-resolution converter may estimate the relationship between the high-resolution sinograms and the low-resolution sinograms, based on information unitarily indicating blurring and down-sampling, and information indicating a motion in the at least one wobble position.

The high-resolution converter may select data of positions corresponding to at least one angle from the extracted sinograms, using a Monte Carlo simulation, and may estimate the blur kernel based on the selected data.

The high-resolution converter may first calculate a part of a matrix indicating blurring and down-sampling with respect to at least one angle based on the extracted sinograms, and may derive a remaining part of the matrix based on the calculated result.

According to an aspect of the present invention, there is also provided an apparatus for generating an image, including a signal classifier to classify, based on a position of a PET, input signals applied through a motion of an entire PET detector or a bed motion, a first image generator to generate a first image set by reconstructing the classified input signals, a parameter measurement unit to measure a point spread function (PSF) based on the first image set, and a second image generator to generate second image information by applying a super-resolution algorithm based on the PSF.

The first image set may correspond to a set with respect to a low-resolution image, and the second image information may correspond to information with respect to a high-resolution image.

The first image generator may generate the first image set, using at least one of analytic reconstruction algorithms, and iterative reconstruction algorithms.

The second image generator may generate the second image information using the PSF as a blur model.

The second image generator may generate the second image information by applying, as the super-resolution algorithm, the following equation:

$${\hat{x}}^{n + 1} = {\hat{x}}^{n} + β [ {\sum }_{k = 1}^{p} {W}_{k}^{T} ( {y}_{k} - {W}_{k} {\hat{x}}^{n} ) - α {C}^{T} C {\hat{x}}^{n} ]$$

where yₖ may correspond to a first image set (1≦k≦p), p may correspond to a number of the first image set, \hat{X}ⁿ may correspond to n^{th} second image information, Wₖ may correspond to a matrix value comprising down-sampling, blurring, and translation, C may correspond to a high-pass filter value, α may correspond to a smoothness parameter, β may correspond to a convergence parameter, and T may correspond to a transpose matrix.

When a negative number is excluded from the first image set, the second image generator may generate the second image information by applying an MLEM algorithm of the following equation:

$${\hat{x}}^{n + 1} = {\hat{x}}^{n} \frac{{\sum }_{k = 1}^{p} {W}_{k}^{T} ( \frac{{y}_{k}}{{W}_{k} {\hat{x}}^{n}} )}{{\sum }_{k = 1}^{p} {W}_{k}^{T} 1 + λ \frac{\partial F ( {\hat{x}}^{n} )}{\partial x}}$$

where yₖ may correspond to a first image set (1≦k≦p), p may correspond to a number of the first image set, \hat{X}ⁿ may correspond to n^{th} second image information, Wₖ may correspond to a matrix value comprising down-sampling, blurring, and translation, T may correspond to a matrix transpose,

$$λ \frac{\partial F ( {\hat{x}}^{n} )}{\partial x}$$

may correspond to a regularization term using a total-variation, and λ may correspond to a regularization parameter, a value indicating a degree of regularization.

According to an aspect of the present invention, there is also provided an apparatus for generating an image, including a signal classifier to dispose a point source at each pixel position of a high-resolution image through a motion of an entire PET detector or a bed motion, and to classify, based on a position of a PET, input signals applied through the motion, a first image generator to generate a first image set by reconstructing the classified input signals, a parameter measurement unit to measure a PSF based on the first image set, and a second image generator to generate second image information by applying a super-resolution algorithm based on the PSF. The second image generator may obtain data corresponding to the point source for the each pixel position, and may calculate a blur kernel for the each pixel position based on the obtained data, based on the super-resolution algorithm.

Also, the second image generator may compensate for at least one of position correction problem of an object, caused by a parallax error in the second image information, and a tangential blur problem caused by a size of the detector, based on blur kernels of a low-resolution image that may be converted by blurring a high-resolution image or down-sampling the high-resolution image, and a low-resolution image calculated using a Monte Carlo simulation.

According to an aspect of the present invention, there is also provided a method of generating an image, including classifying, based on a position of a PET, input signals applied through a motion of an entire PET detector or a bed motion, generating a first image set by reconstructing the classified input signals, measuring a PSF based on the first image set, and generating second image information by applying a super-resolution algorithm based on the PSF.

According to an aspect of the present invention, there is also provided a method of generating an image, including disposing a point source at each pixel position of a high-resolution image through a motion of an entire PET detector or a bed motion, classifying, based on a position of a PET, input signals applied through the motion, generating a first image set by reconstructing the classified input signals, measuring a PSF based on the first image set, generating second image information by applying a super-resolution algorithm based on the PSF, and obtaining data corresponding to the point source for the each pixel position, and calculating a blur kernel for the each pixel position based on the obtained data, by applying the super-resolution algorithm.

The generating of the second image information may compensate for at least one of position correction problem of an object, caused by a parallax error in the second image information, and a tangential blur problem caused by a size of the detector, based on blur kernels of a low-resolution image that may be converted by blurring a high-resolution image or down-sampling the high-resolution image, and a low-resolution image calculated using a Monte Carlo simulation.

### EFFECT OF THE INVENTION

According to an aspect of the present invention, a high-resolution image may be reconstructed in a positron emission tomography (PET) system that may use a motion of an entire detector or a bed motion.

According to an aspect of the present invention, a high-resolution image may be obtained, by applying a super-resolution algorithm to sinograms.

According to an aspect of the present invention, a super-resolution algorithm that may be based on a maximum likelihood expectation maximization (MLEM) algorithm or a maximum a priori expectation maximization (MAP-EM) algorithm may be applied, and thereby sinograms may have only a positive number to maintain a characteristic of a PET sinogram.

According to an aspect of the present invention, a super-resolution image may be generated based on a point spread function (PSF) according to a position of a PET image.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a photography apparatus according to an embodiment of the present invention;

FIG. 2 is a diagram illustrating a configuration of sampling sinograms by moving an entire detector or a bed in a positron emission tomography (PET) system according to an embodiment of the present invention;

FIG. 3 is a diagram illustrating an apparatus for improving resolution according an embodiment of the present invention;

FIG. 4 is a graph to describe improving resolution by an apparatus according to an embodiment of the present invention;

FIGS. 5A through 5D are diagrams to describe improving resolution by an apparatus according to an embodiment of the present invention;

FIGS. 6A through 6C are diagrams to describe improving resolution by an apparatus according to an embodiment of the present invention;

FIG. 7 is a flowchart illustrating a method of improving resolution according to an embodiment of the present invention;

FIG. 8 is a diagram illustrating a configuration of an apparatus for generating an image according to an embodiment of the present invention;

FIG. 9 is a flowchart illustrating a method of generating an image according to an embodiment of the present invention;

FIG. 10 is a diagram illustrating a scene of a PET, in a method of generating an image according to an embodiment of the present invention;

FIG. 11 is a diagram illustrating a process of measuring of input signals of PET equipment that may generate the input signals using an apparatus for generating an image according to an embodiment of the present invention;

FIG. 12 is a diagram illustrating a process of measuring a point spread function (PSF) using an apparatus for generating an image according to an embodiment of the present invention;

FIG. 13 is a diagram to describe a general form of a parallax error; and

FIG. 14 is a diagram to describe a correlation between a size of a detector and a tangential blur.

### DETAILED DESCRIPTION

Exemplary embodiments are described below to explain the present invention by referring to the figures.

When it is determined that a detailed description related to a related known function or configuration which may make the purpose of the present invention unnecessarily ambiguous in describing the present invention, the detailed description will be omitted here. Also, terminologies used herein are defined to appropriately describe the exemplary embodiments of the present invention and thus may be changed depending on a user, the intent of an operator, or a custom. Accordingly, the terminologies must be defined based on the following overall description of this specification. Reference will now be made in detail to exemplary embodiments of the present invention, examples of which are illustrated in the accompanying drawings, wherein like reference numerals refer to the like elements throughout.

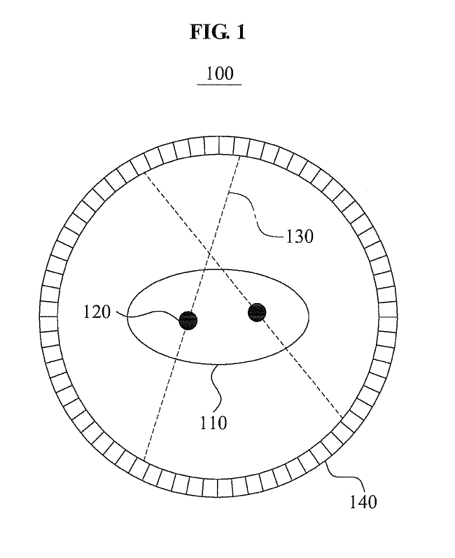

FIG. 1 is a diagram illustrating a photography apparatus 100 according to an embodiment of the present invention. Referring to FIG. 1, the photography apparatus 100 may inject positrons 120 into a measurement target 110. When the positrons 120 meet an electron inside the measurement target 110, the positrons 120 may irradiate two gamma photons at an angle of about 180° and may be annihilated. Projection information with respect to a distribution of the positrons 120 in the measurement target 110 of corresponding rays 130 may be obtained by measuring the gamma photons that may almost simultaneously arrive at a detector 140.

The projection information may be classified based on an angle of the corresponding rays 130 of the annihilated positrons and a distance from an origin. Also, sinograms may be generated using the projection information.

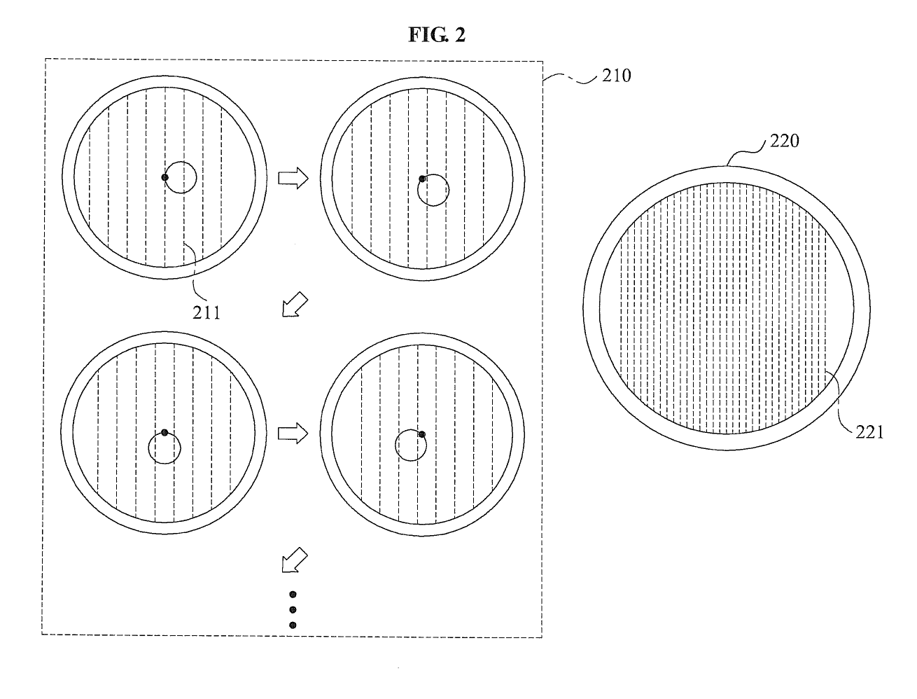

FIG. 2 is a diagram illustrating a configuration of sampling sinograms by moving an entire detector or a bed in a positron emission tomography (PET) system according to the first embodiment of the present invention. For the sampling, the PET system may make the entire detector or a target to be photographed, for example, a patient regularly perform a circular movement, thereby obtaining multiple sets of sampling data.

Referring to FIG. 2, the apparatus for improving resolution according to the first embodiment may obtain multiple sets of sinograms by moving the entire detector or the bed using the photography apparatus, and may reconstruct a super-resolution (SR) PET image by applying an SR algorithm to the obtained sinograms.

The apparatus for improving resolution may obtain a set 210 of sinograms, using sinograms 211 obtained in each position by moving the entire detector or the bed. The set 210 of the sinograms may correspond to data measured directly in the PET system, and may accordingly more precisely indicate relationship between high-resolution (HR) and low-resolution (LR). Application of the SR algorithm to the sinograms may be more effective than application of the SR algorithm to the obtained PET image.

The apparatus for improving resolution may obtain HR sinograms 221 through the photography apparatus 220, by applying the SR algorithm.

In FIG. 1, sets of sinograms may be obtained by moving the entire detector of the photography apparatus of the PET system. Also, an effect analogous to moving the entire detector may be achieved by moving the bed in which a patient may lie. In this instance, samples of each sinogram may remain in a blur state by at least one factor among a positron range of radioactive rays, non-colinearity of the radioactive rays, and a size of a detector. Accordingly, even when a PET image is reconstructed using the sinograms having an increased number of samples, overall resolution may remain unchanged.

When the entire detector or the bed is moved, there may be an additional sample between the existing samples.

Thus, samples of sets of additional sinograms may be disposed between samples of a single sinogram, and accordingly HR sinograms may be obtained by applying an SR algorithm. That is, resolution of a PET image to be reconstructed may be improved by applying the SR algorithm to the sinograms obtained in the set 210 of the sinograms.

As another embodiment, the apparatus for improving resolution may use a discrete wobble. In this instance, in order to stop movement of the detector or the bed, the weight of the detector or the bed may be needed to be sufficiently light.

When the apparatus for improving resolution uses a continuous wobble, a motion may exist in a single LR and accordingly a degree of blur of LR sinograms may be high. Conversely, when the apparatus for improving resolution uses the discrete wobble, there may be less motion during a measurement, and accordingly the degree of the blur of the measured LR sinograms may be relatively low.

The apparatus for improving resolution may include a process for reducing the blur, however a better result may be derived by reducing the degree of the blur of the LR sinograms using the discrete wobble.

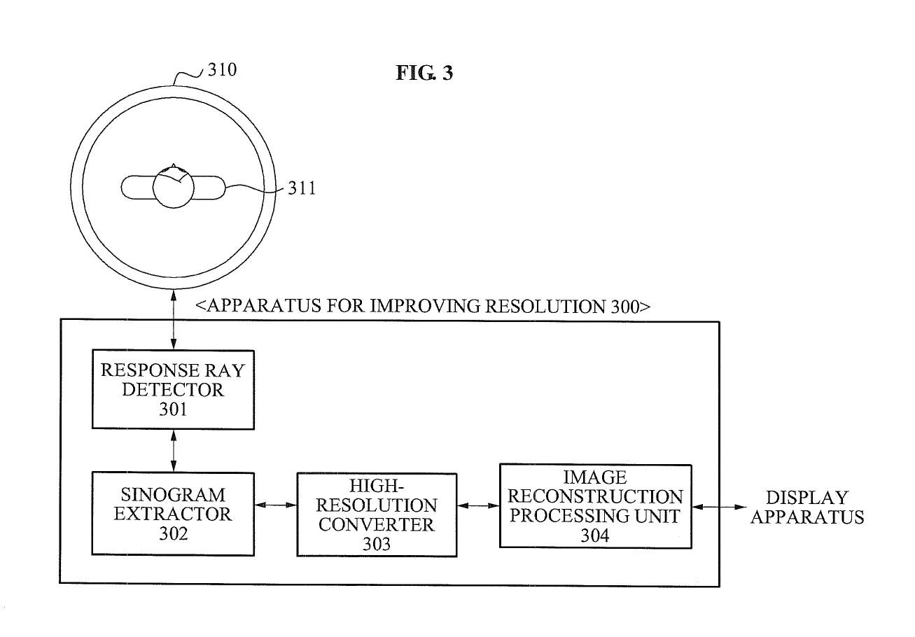

FIG. 3 is a diagram illustrating an apparatus 300 for improving resolution according to the first embodiment of the present invention.

The apparatus 300 for improving resolution may detect response rays in response to gamma photons that may be irradiated from a measurement target 311 through a photography apparatus 310, may generate SR sinograms, and may obtain an SR PET image using the generated SR sinograms.

The apparatus 300 for improving resolution may include a response ray detector 301, a sinogram extractor 302, a high-resolution converter 303, and an image reconstruction processing unit 304.

The response detector 301 may detect response rays in response to radioactive rays irradiated to a measurement target.

The sinogram extractor 302 may extract sinograms from the detected response rays.

Particularly, a plurality of response rays may be converted into sinograms, and a plurality of sinograms may be obtained by measuring gamma photons that may be irradiated from the measurement target 311.

The high-resolution converter 303 may convert the extracted sinograms into HR sinograms.

In order to reconstruct an SR PET image, the obtained sinograms may be converted into the HR sinograms.

The high-resolution converter 303 according to the first embodiment of the present invention may generate a set of HR sinograms, using a maximum a priori expectation maximization algorithm (MAP-EM) such as a maximum likelihood expectation maximization (MLEM) algorithm.

The high-resolution converter 303 may generate the set of the SR sinograms through an iterative computation of Equation 1.

$${\hat{x}}^{n + 1} = {\hat{x}}^{n} \frac{{\sum }_{k = 1}^{K} {W}_{k}^{T} ( \frac{{y}_{k}}{{W}_{k} {\hat{x}}^{n}} )}{{\sum }_{k = 1}^{K} {W}_{k}^{T} 1 + λ \frac{\partial F ( {\hat{x}}^{n} )}{\partial x}} \qquad [ Equation 1 ]$$

Here, yₖ may correspond to a set of sinograms of a range of 1≦k≦p, wherein p may correspond to a number of sinograms included in the set of the sinograms.

Also, \hat{X}ⁿ may correspond to HR sinograms estimated from an N^{th} repetition, and Wₖ may correspond to a matrix including down-sampling, blurring, and translation.

According to the first embodiment of the present invention, a non-negative characteristic may be maintained in the computation of sinograms, by applying the SR algorithm that may be based on the MLEM algorithm.

That is, a sinogram of PET may have a characteristic that may have not have a negative characteristic. The non-negative characteristic of an SR sinogram may be maintained by applying the MLEM algorithm to the high-resolution converter 303.

The image reconstruction processing unit 304 may reconstruct an SR PET image from the converted SR sinograms.

The image reconstruction processing unit 304 according to the first embodiment of the present invention may reconstruct an SR PET image using a set of the converted SR sinograms.

As another embodiment, the image reconstruction processing unit 304 may reconstruct the SR PET image, using an analytic reconstruction algorithm, or an iterative reconstruction algorithm.

As another embodiment, the image reconstruction processing unit 304 may reconstruct the SR PET image using the analytic reconstruction algorithm similar to a filtered-back projection (FBP) algorithm.

As another embodiment, the image reconstruction processing unit 304 may reconstruct the SR PET image using the iterative reconstruction algorithm similar to an ordered-subset expectation maximization (OSEM) algorithm.

Further, the high-resolution converter 303 may automatically estimate a blur kernel of a PET image based on information measured in the PET detector, and may use the blur kernel.

Wₖ of Equation 1 may be derived from a model of the following Equation 2.

yₖ=Wₖx+nₖ [Equation 2]

yₖ may correspond to an LR sinogram measured in a k^{th} wobble position, and X may correspond to an HR sinogram. Wₖ may may correspond to a matrix indicating a relationship between the HR sinogram and the LR sinogram, and nₖ may correspond to a noise component that may enable yₖ to be a random vector having a Poisson distribution.

Further, Wₖ may be estimated by the following Equation 3.

Wₖ=DBRₖ [Equation 3]

Here, Rₖ may correspond to a matrix indicating movement information of a sinogram in a k^{th} wobble position, and D may correspond to a matrix indicating down-sampling. Since a number of samples of HR sinograms may be greater than a number of samples of LR sinograms, down-sampling may be needed to be performed. Also, B may correspond to a matrix indicating a blur between the HR sinograms and the LR sinograms.

In the PET system, a blur may occur even without a motion, due to physical phenomena such as a positron range, a non-colinearity, a crystal width, a block effect, and the like. Different blurs may occur depending on a configuration of the detector. That is, every PET system may have its own blur. Accordingly, in order to apply an effective SR, it may be important to perceive an intrinsic blur kernel of the PET system.

In a conventional apparatus for improving resolution, an experiment may be performed on the assumption that a blur kernel of a PET system of an experiment target may be perceived in advance. The conventional apparatus for improving resolution may predict the blur kernel based on information with respect to a preset blur kernel. However, each PET system may have a different blur kernel, and accordingly the high-resolution converter 303 may accurately estimate the information with respect to the blur kernel of the PET system, thereby increasing an application effect of the SR.

As another example, the high-resolution converter may estimate the blur kernel of the PET system, using a Monte Carlo simulation. The high-resolution converter may use the Monte Carlo simulation during processes of deblurring and PET image reconstruction. In this instance, the high-resolution converter may search for the blur kernel according to the Monte Carlo simulation, based on a point source. However, in this method, a number of samples of Monte Carlo simulation results, and a number of samples of data to be actually used may be required to be identical.

However, as described above, since the HR sinograms may be denser than the LR sinograms, the HR sinograms may have a number of samples greater than the LR sinograms. Accordingly, a value measured by the Monte Carlo simulation may be needed to be converted through a series of processing procedures.

The high-resolution converter may classify a case of a spatially invariant blur, and a case of a spatially variant blur, in an estimation of the blur kernel. The sinograms of the PET system may have a characteristic having the spatially variant blur, and accordingly an embodiment with respect to the characteristic having the spatially variant blur will be first described, hereinafter.

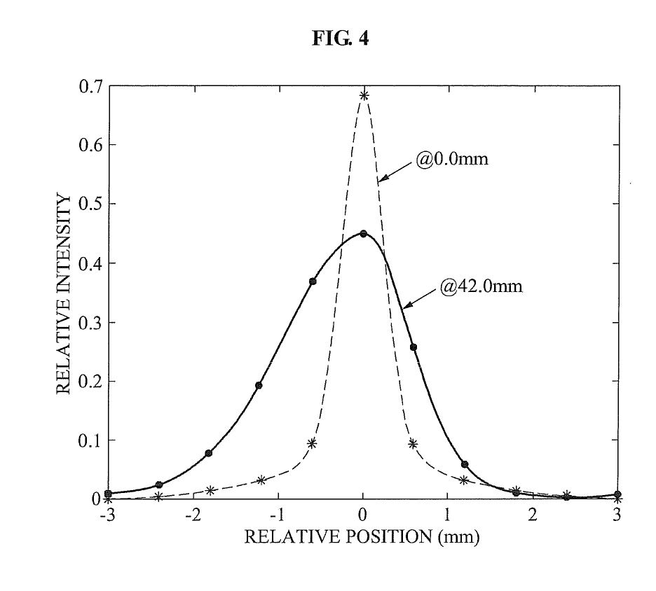

FIG. 4 is a graph to describe improving resolution by an apparatus according to an embodiment of the present invention, which illustrates an example of a profile of sinograms of a point source that may be obtained through a Monte Carlo simulation. In the graph of FIG. 4, in order to easily recognize blurring, a relative position difference may be compensated for, in advance. Also, the graph may be a result of an experiment performed using, as a model, a microR4 PET system corresponding to a PET system for small animals.

In general a PET system, a difference may occur according to a position of blurring. However, the difference according to a position of blurring may be relatively significant, or relatively insignificant, depending on a configuration of the PET system.

Since a central part of PET sinograms may have the best resolution, an area of interest of a target to be photographed may be mostly disposed on a center of an image, in an operation of the apparatus for improving resolution. In this instance, an area excluding the area of interest may allow an error that may occur when inaccurate blurring is not accurately recognized, and accordingly a case of a spatially invariant blur may be assumed.

When comparing each case, the spatially invariant blur may have a rather low accuracy, yet may easily estimate a blur kernel, and may reduce a time required for applying the SR.

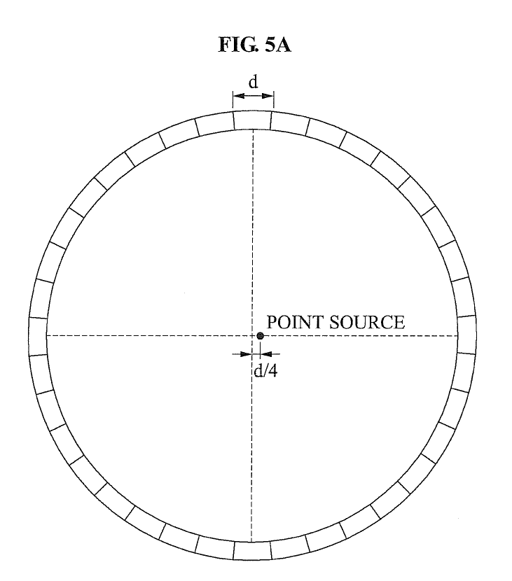

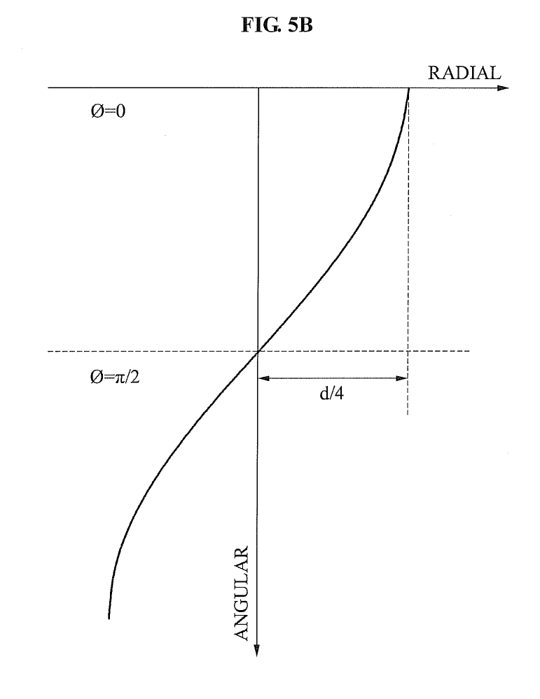

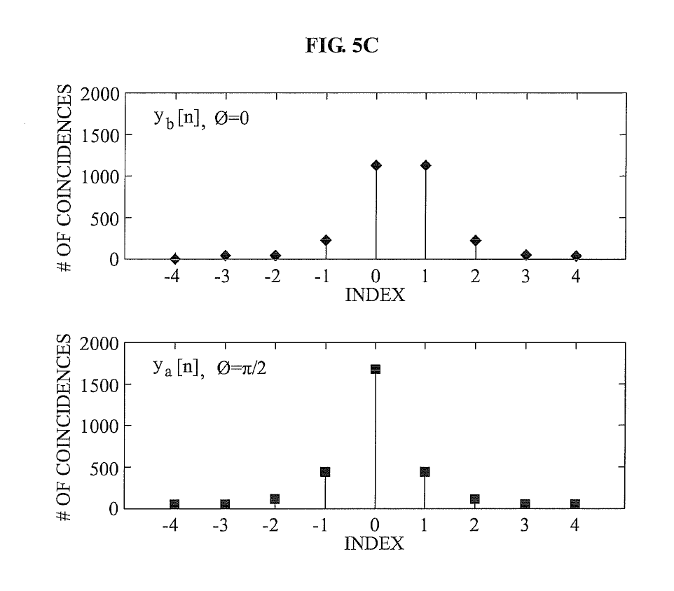

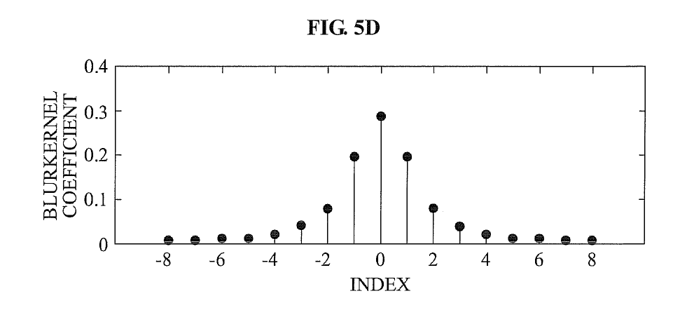

FIGS. 5A through 5D are diagrams to describe improving resolution by an apparatus according to an embodiment of the present invention, which in particular relates to a case of using a spatially invariant blur.

Here, the blur may be regarded as spatially invariant, and accordingly it may be assumed that a blur kernel, which may be estimated in a center of a sinogram, may correspond to a blur in an entire area of the sinogram. Also, HR sinograms may have a characteristic of having a number of samples greater than a number of samples of LR sinograms, and accordingly it may be assumed that the number of the samples of the HR sinograms may be twice greater than the number of the samples of the LR sinograms, in the embodiment.

Referring to FIG. 5A, a point source may be disposed in a position that may be d/4 apart from a center, where d may correspond to a crystal width of a detector. Referring to FIG. 5B, data corresponding to 0° and 90° may be selected from sinograms that may be obtained through a Monte Carlo simulation. The selected data may be represented in separate graphs as shown in FIG. 5C. Also, the data represented in the separate graphs may be disposed to be misaligned as shown in FIG. 5D, and thereby an estimation may be performed by integrating the data into information with respect to the blur kernel.

According to the embodiment, an experiment may be performed with respect to the case that a number of samples of HR sinograms may be greater than a number of samples of LR sinograms, by a factor of two. In a case where there number of samples of HR sonograms is greater by a factor if two, a blur kernel may be estimated by selecting and using data in a position where an angle of a sinogram may correspond to φᵢ, which may be expressed as the following Equation 4.

$${φ}_{i} = {cos}^{- 1} ( \frac{2 i}{M} ) , \\ \frac{M - 1}{2} \leq i \leq \frac{M}{2} , \qquad [ Equation 4 ]$$

i is an integer

Here, M may indicate multiples of the number of the samples of the HR sinograms, and the number of the samples of the LR sinograms, and may correspond to an integer.

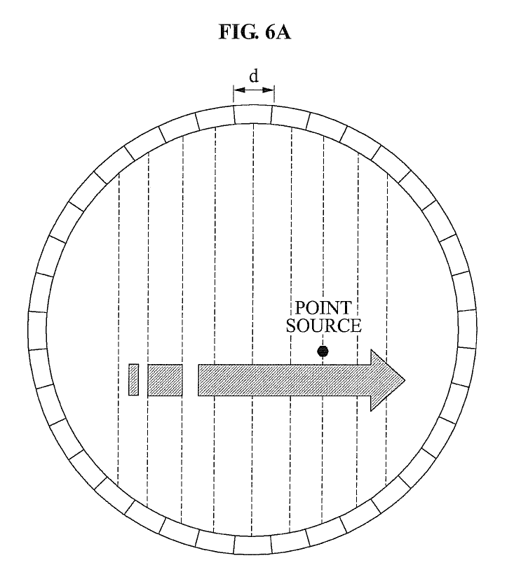

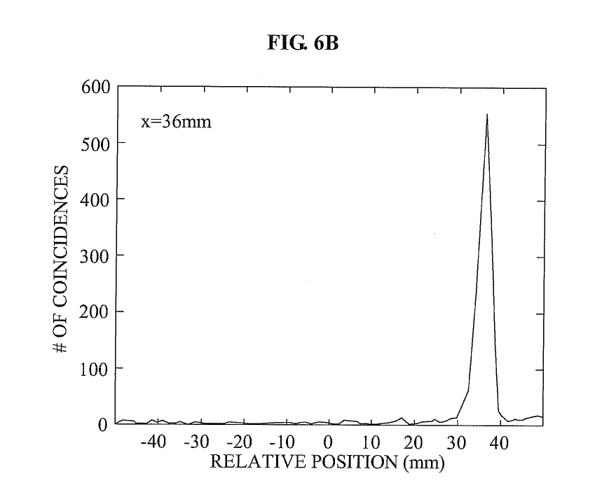

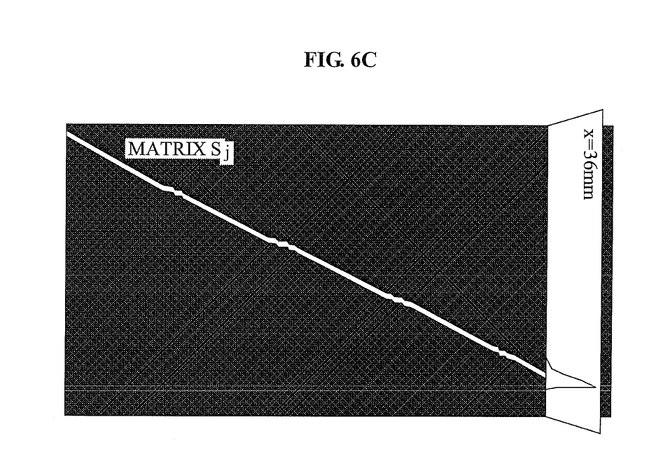

FIGS. 6A through 6C are diagrams to describe improving resolution by an apparatus according to an embodiment of the present invention. In this instance, a spatially variant blur may be used in the embodiment.

Wₖ may be dissected as expressed in the following Equation 5.

Wₖ=SRₖ [Equation 5]

Here, S may correspond to a matrix unitarily indicating blurring and down-sampling, and may correspond to a block matrix including a matrix Sⱼ. Sⱼ may correspond to a matrix indicating blurring and down-sampling with respect to a single angle φⱼ among sinograms, and Rₖ may correspond to a matrix indicating a motion in a k^{th} wobble position.

In order to obtain a component of the matrix Sⱼ with respect to the angle φⱼ, multiple pages of sinograms may be obtained by moving the point source from the center of an image, as shown in FIG. 6A. Here, the movement may be a direction vertical to the angle of the sinograms desired to be obtained. Also, an interval and a number of times of moving the point source may be equally selected, in response to a sample spacing and the number of samples of the HR sinograms. Further, data of the sinograms corresponding to the angle desired to be obtained may be extracted from the multiple pages of the obtained sinograms.

Referring to FIG. 6B, an example of the extracted data may be represented, which may be an example of data extracted when the point source is moved by 36 mm from the center.

A matrix Sⱼ as shown in FIG. 6C may be configured using the extracted data of FIG. 6. Here, a detector of a PET system may be symmetric, and thus data with respect to any of a part of the matrix Sⱼ, that is, a left part or a right part may be calculated and data with respect to a remaining part of the matrix Sⱼ may be derived based on the calculated data. In this instance, without calculating Sⱼ with respect to all angles, the matrix Sⱼ may be calculated with respect to at least one angle, and data of the calculated Sⱼ may be repeatedly used.

Further, the high-resolution converter may provide an optimization function. The image reconstruction processing unit may use an MAP-EM with respect to a Poisson distribution. The apparatus for improving resolution may calculate the aforementioned Equation 1 based on the MAP-EM.

Here, the algorithm for the MAP-EM may use regularization and may maximize a likelihood function where yₖ may be measured with respect to a solution x of Equation 1. The measured yₖ may correspond to a random vector having a Poisson distribution, and thus the apparatus for improving resolution according to the fourth embodiment may reflect a noise characteristic of yₖ, and may derive a unique solution through the regularization.

As another embodiment,

$$λ \frac{\partial F ( {\hat{x}}^{n} )}{\partial x}$$

in Equation 1 may correspond to a regularization term, and the image reconstruction processing unit of the apparatus for improving resolution according to the embodiment may use a total-variation. Here, λ may indicate a regularization parameter for adjusting an effect of the regularization term.

A single sample in sinograms may correspond to a number of gamma rays that may be measured in a pair of predetermined detectors, among detectors of the PET system, and thus may have a positive number. A solution calculated in Equation 5 may correspond to a sinogram, and accordingly may have a positive number.

The image reconstruction processing unit may calculate the unique solution using the regularization.

The SR algorithm may generally have an ill-posed problem. When a predetermined cost function, for example, a likelihood function with respect to a Poisson distribution, is maximized or minimized, various solutions that may have the same cost function may exist. Accordingly, the apparatus for improving resolution may estimate the unique solution through the regularization.

As another embodiment, the high-resolution converter of the apparatus for improving resolution may use total-variation regularization that may have a characteristic of preserving an edge having a great gradient.

Particularly, the image reconstruction processing unit may calculate a solution corresponding to a positive number, by adjusting several parameters.

For example, according to a regularization characteristic that may be used in the MAP-EM, a denominator term of Equation 4 may correspond to a negative number, and thus the solution may correspond to a negative number. In this instance, the image reconstruction processing unit may limit

$$\frac{\partial F ( {\hat{x}}^{n} )}{\partial x}$$

to have a value only within a predetermined range, using the total-variation regularization. Also, the image reconstruction processing unit may set λ to be a proper value so that the denominator term and the solution of Equation 4 may correspond to positive numbers.

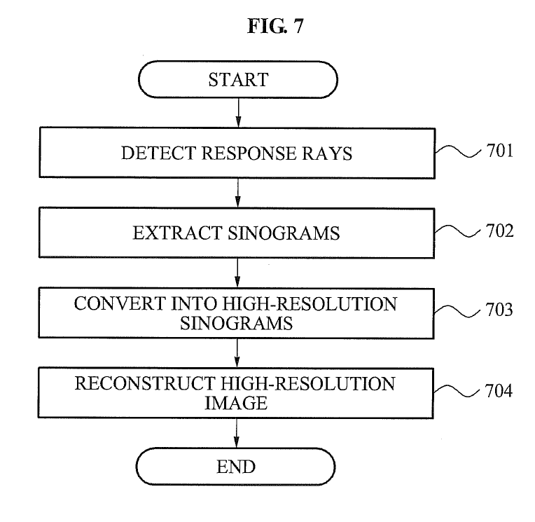

FIG. 7 is a flowchart illustrating a method of improving resolution according to an embodiment of the present invention.

The method of improving resolution according to the embodiment may obtain multiple sets of sinograms by moving an entire detector or a bed using a photography apparatus, and may reconstruct an SR PET image by applying an SR algorithm to the obtained sinograms.

In operation 701, the method of improving resolution may detect response rays, in response to radioactive rays that may be irradiated to a measurement target.

In operation 702, the method of improving resolution may extract sinograms from the detected response rays.

In operation 702, a set of sinograms may be obtained by moving the entire detector or the bed. In this instance, the set of the extracted sinograms may correspond to data measured directly in a PET system, and may accordingly indicate relationship between the sinograms more precisely than relationship between HR and LR.

In operation 703, the method of improving resolution may convert the extracted sinograms into HR sinograms.

An application of the SR algorithm to the sinograms may be more effective than an application of the SR algorithm to the obtained PET image. Thus, the extracted sinograms may be converted into the HR sinograms, by applying the SR algorithm, in operation 703.

In operation 704, the method of improving resolution may reconstruct an HR image from the converted HR sinograms.

In operation 704, the set of the converted HR sinograms may be reconstructed to be the SR PET image, using an analytic reconstruction algorithm, or an iterative reconstruction algorithm.

The method of improving resolution according to the embodiment may convert the extracted plurality of the sinograms into HR sinograms, using at least one of an SR algorithm and an MLEM algorithm, in order to reconstruct the HR image.

In the PET system that may use a motion of the entire detector or a motion of the bed, an image having high resolution may be reconstructed, and an HR image may be obtained by applying an SR algorithm to the sinograms.

Also, according to an embodiment of the present invention, a non-negative characteristic of a PET sinogram may be maintained using a positive number only, in computation of sinograms, by applying the SR algorithm that may be based on the MLEM algorithm.

The apparatus for improving resolution may use a discrete wobble to decrease a degree of blur of LR sinograms.

Also, the image reconstruction processing unit may have a characteristic of automatically estimating a blur kernel of the PET image based on information measured in the PET detector, and may estimate a correlation between HR sinograms and LR sinograms based on at least one of the LR sinograms that may be measured in at least one wobble position, a noise component that may enable the LR sinograms to be a random vector having a Poisson distribution, and the HR sinograms.

The image reconstruction processing unit may calculate at least one of a motion matrix in at least one wobble position, a matrix indicating down-sampling, and a matrix indicating a blur between the HR sinograms and the LR sinograms, based on the correlation between the estimated HR sinograms and the LR sinograms.

The image reconstruction processing unit may select data in a position corresponding to at least one angle, using a Monte Carlo simulation, and may estimate a blur kernel based on the selected data.

In a case of a spatially variant blur, the image reconstruction processing unit may calculate at least one of a block matrix of matrixes indicating blurring and down-sampling with respect to at least one angle, and a matrix indicating a motion in at least one wobble position, based on the correlation between the estimated HR sinograms and the LR sinograms.

The image reconstruction processing unit may first calculate a part of a matrix indicating blurring and down-sampling with respect to at least one angle, among the sinograms, and may derive a remaining part of the matrix using the calculated result.

The image reconstruction processing unit may calculate a unique solution according to regularization, using an MAP-EM algorithm with respect to a Poisson distribution, or a total-variation regularization algorithm.

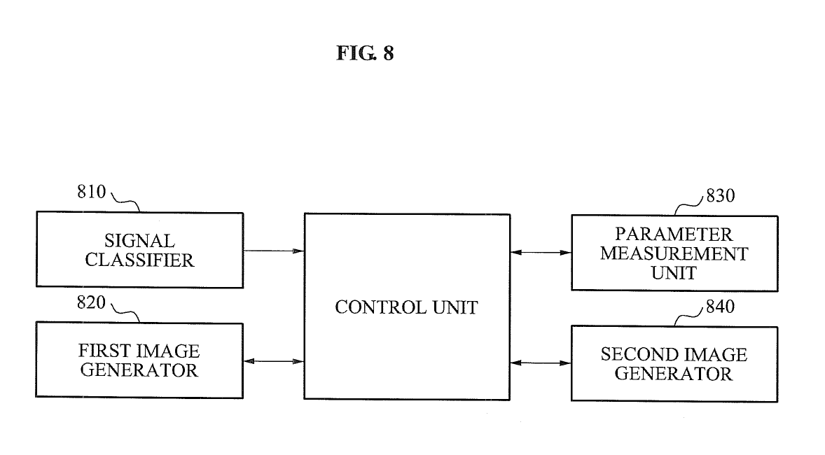

FIG. 8 is a diagram illustrating a configuration of an apparatus for generating an image according to an embodiment of the present invention.

The apparatus for generating the image may detect response rays, in response to radioactive rays that may be irradiated to a measurement target, may extract sinograms from the detected response rays, and may reconstruct an FIR image by converting the extracted sinograms into HR sinograms.

Referring to FIG. 8, the apparatus for generating the image may include a signal classifier 810, a first image generator 820, a parameter measurement unit 830, and a second image generator 840.

The apparatus for generating the image may apply input signals through a motion of an entire PET detector or a bed motion, may generate a first image set based on the input signals that may be classified based on a position of the PET detector, may measure a PSF based on the first image set, and then may generate second image information that may be improved through an SR imaging technique.

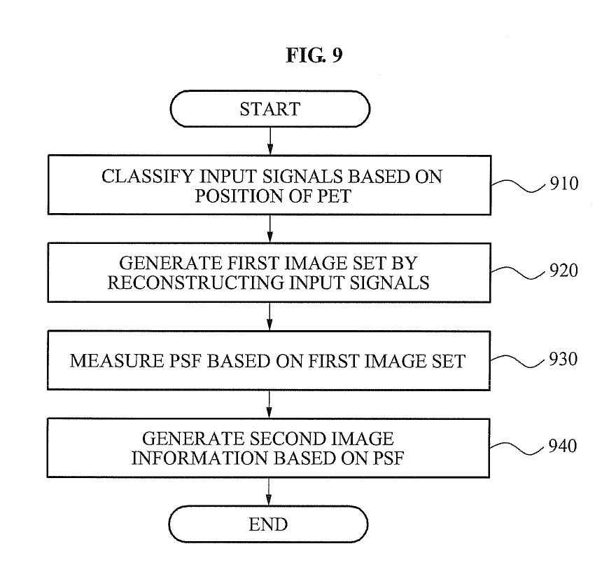

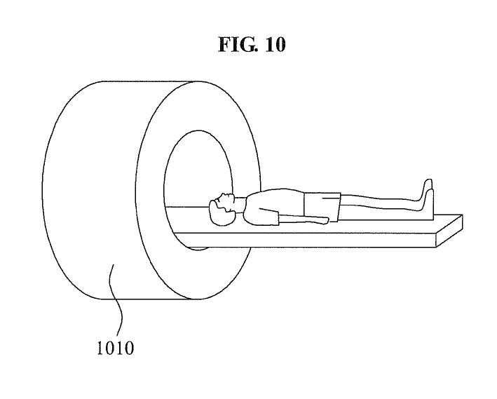

A method that may generate an improved image through the SR imaging technique, using the apparatus for generating the image according to this embodiment will be further described with reference to FIGS. 9 and 10.

FIG. 9 is a flowchart illustrating a method of generating an image according to the embodiment of the present invention, described in FIG. 8, and FIG. 10 is a diagram illustrating a scene of a PET, in a method of generating an image according to the embodiment of the present invention, described in FIG. 8.

The apparatus for generating the image may generate image information based on an SR algorithm, using input signals that may be applied when a measurement target passes through a PET detector 1010, as illustrated in FIG. 10.

The apparatus for generating the image may generate the image information by applying the input signals that may be measured through a circular movement, such as a wobble motion of an entire PET detector or a bed where a patient may lie.

The apparatus for generating the image may classify, based on a position of the PET, the input signals applied through the motion of the entire PET detector or the motion of the bed, using the signal classifier 180, in order to generate image information by applying an SR algorithm, in operation 910.

Then, the apparatus for generating the image may generate a first image set by reconstructing the classified input signals, using the first image generator 820, in operation 920.

In this instance, the first image set may correspond to a set with respect to LR images. Thus, the apparatus for generating the image may refer to an image set including at least one image information, and may generate second image information using the first image information including the at least one image information.

For example, the apparatus for generating the image may generate the second image information, the information of a sheet of a 128×128 image, using the first image set including information of four sheets of 64×64 images.

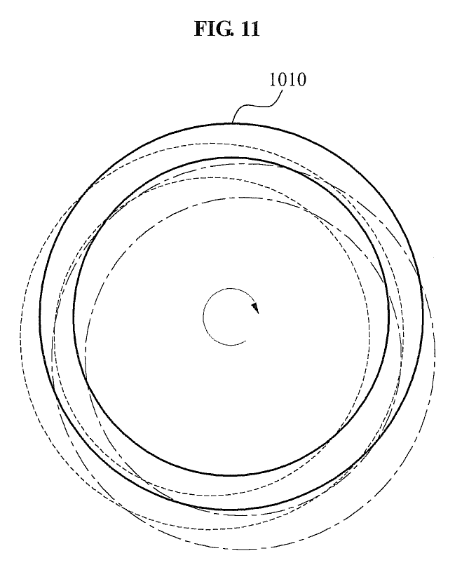

FIG. 11 is a diagram illustrating a process of measuring of input signals of PET equipment that may generate the input signals using an apparatus for generating an image according to an embodiment of the present invention.

For example, as illustrated in FIG. 11, the apparatus for generating the image may obtain multiple reconstructed image sets based on a position of the PET equipment, by measuring input signals when the entire PET 1010 detector performs a circular movement, due to a motion such as wobble, and the like.

In this instance, the image sets that may be applied to the apparatus for generating the image may be regarded as non-integer pixel shifted, and accordingly the SR algorithm may be applicable.

That is, the apparatus for generating the image may classify the measured input signals, based on a position of the PET equipment since the entire PET detector may be moved by the wobble motion, and may generate multiple first image sets by reconstructing the input signals.

The first image information may be translated into one another, which may be analogous to photographing the same target using a camera with infinitesimal motions. Thus, better-resolution image information may be generated by applying the SR algorithm using the translated first image set.

That is, the apparatus for generating the image may obtain the input signals through the wobble motion, and may generate a set of LR images corresponding to the first image set by classifying the input signals based on the position of the PET equipment, and by reconstructing the input signals.

In this instance, various reconstruction algorithms may be used as a reconstruction algorithm that may be used in the apparatus for generating the image, for example, an analytic reconstruction algorithm such as an FBP, an iterative reconstruction algorithm such as an OSEM, and the like.

In operation 930, the apparatus for generating the image according to the embodiment may measure a PSF based on the first image set, using the parameter measurement unit 830.

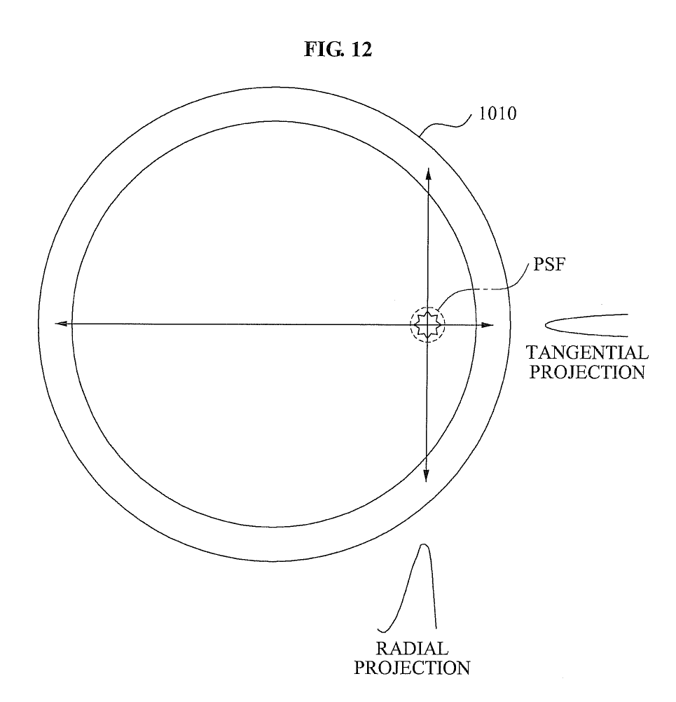

FIG. 12 is a diagram illustrating a process of measuring a PSF using an apparatus for generating an image according to an embodiment of the present invention.

Generally, image information measured by PET equipment may have a blur phenomenon caused by a positron range, non-colinearity, a size of a detector, and the like. For example, a PSF of a sample measured in a ring-shape PET system or a cylindrical PET system may be different based on a position.

The apparatus for generating the image may obtain a better-resolution image, using the PSF that may be different based on a position, as a blur model of an SR technique, using a characteristic of changing a shape of the PSF based on a position of the PET detector, as illustrated in FIG. 12.

That is, the PSF of the reconstructed first image set may be changed based on a position. Accordingly, using this characteristic, the apparatus for generating the image may obtain a more improved image using a PSF that may be different based on the position of the PET, as a kernel of the SR algorithm when image information is generated by measuring the PSF based on a position of the first image set, and by applying the SR algorithm.

In operation 940, the second image generator 840 of the apparatus for generating the image may generate second image information by applying the SR algorithm based on the PSF. Here, the second image information according to the embodiment described with reference to FIG. 8 may correspond to information with respect to an HR image.

The second image generator 840 of the apparatus for generating the image may finally generate the second image information of HR that may have better resolution, using the PSF as a blur model.

The apparatus for generating the image may generate the second image information corresponding to the HR image information, by applying the following SR algorithm.

For example, the second image generator 840 may generate the second image information, by applying, as the SR algorithm, the following Equation 6.

$${\hat{x}}^{n + 1} = {\hat{x}}^{n} + β [ {\sum }_{k = 1}^{p} {W}_{k}^{T} ( {y}_{k} - {W}_{k} {\hat{x}}^{n} ) - α {C}^{T} C {\hat{x}}^{n} ] \qquad [ Equation 6 ]$$

Here, yₖ may correspond to a first image set (1≦k≦p), p may correspond to a number of the first image set, and \hat{X}ⁿ may correspond to n^{th} second image information.

Wₖ may correspond to a matrix value including down-sampling, blurring, and translation.

C may correspond to a high-pass filter value, and C^{T}C\hat{x}ⁿ may correspond to a part that may enable a result image to be smooth.

α may correspond to a smoothness parameter, β may correspond to a convergence parameter, and T may correspond to a matrix transpose.

For example, a process of performing

$${\sum }_{k = 1}^{p} {W}_{k}^{T} ( {y}_{k} - {W}_{k} {\hat{x}}^{n} ) ,$$

a portion before α of Equation 6, may correspond to a process of passing through a high-pass filter that may enable the image information to be sharp.

According to another embodiment of the present invention, a process of preforming C^{T}C\hat{x}ⁿ, a portion after α, may correspond to a process of passing through a low-pass filter that may enable the image information to be smooth.

Further, the apparatus for generating the image may adjust a of Equation 6 to determine which process may be given more weight, the process of performing

$${\sum }_{k = 1}^{p} {W}_{k}^{T} ( {y}_{k} - {W}_{k} {\hat{x}}^{n} )$$

or the process of performing C^{T}C\hat{x}ⁿ.

Also, the apparatus for generating the image may continuously update \hat{X}ⁿ of Equation 6, and may determine a size of the update value by adjusting β. For example, when the value of β of Equation 6 is greater than a standard, the apparatus for generating the image may obtain a desired result with less iteration.

When a value of the first image set corresponding to the LR image set is in a non-negative condition, the apparatus for generating the image may generate the second image information through iterative computation using an MLEM algorithm as follows.

That is, when a negative number is excluded from the value of the first image set, the second image generator 840 may generate the second image information by applying the MLEM algorithm of Equation 7.

$${\hat{x}}^{n + 1} = {\hat{x}}^{n} \frac{{\sum }_{k = 1}^{p} {W}_{k}^{T} ( \frac{{y}_{k}}{{W}_{k} {\hat{x}}^{n}} )}{{\sum }_{k = 1}^{p} {W}_{k}^{T}} \qquad [ Equation 7 ]$$

Here, in order to generate the second image information, an initial value \hat{X}⁰ of \hat{X}ⁿ and an LR image yₖ may be required to have a non-negative characteristic. yₖ may correspond to a first image set (1≦k≦p), p may correspond to a number of the first image set, and \hat{X}ⁿ may correspond to n^{th} second image information.

Wₖ may correspond to a matrix value including down-sampling, blurring, and translation. T may correspond to a matrix transpose.

Consequently, the apparatus for generating the image may obtain a result by applying a weighted sum blurring model, in blurring the first image set corresponding to an HR sample.

Here, the PSF may be spatially variant based on the position of the PET 1010 detector that may be obtained by measuring a point source as illustrated in FIG. 12.

The apparatus for generating the image may measure the variant PSF by moving the point source and by repeatedly measuring the point source.

Since the relationship between the HR image and the LR image in the SR algorithm, the apparatus for generating the image may generate an image with better resolution using a PSF of the LR image at the time of generating an HR image.

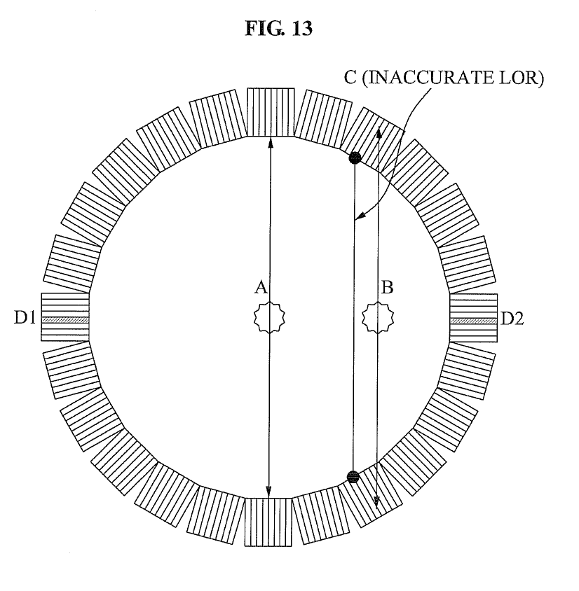

Further, one reason why resolution in the PET may be variant in every spatial position may be a parallax error. FIG. 13 is a diagram to describe a general form of the parallax error.

Referring to FIG. 13, a form of the parallax error may correspond to a geometrical configuration, and the resolution may have a difference based on a distance from the center of the system to a current position.

The center of the system may correspond to A, and a place where an event may occur in the system may correspond to B. In this instance, a probability that a signal may pass through an adjacent crystal and may be detected may be increased, and data may be recorded in an inaccurate LOR corresponding to C.

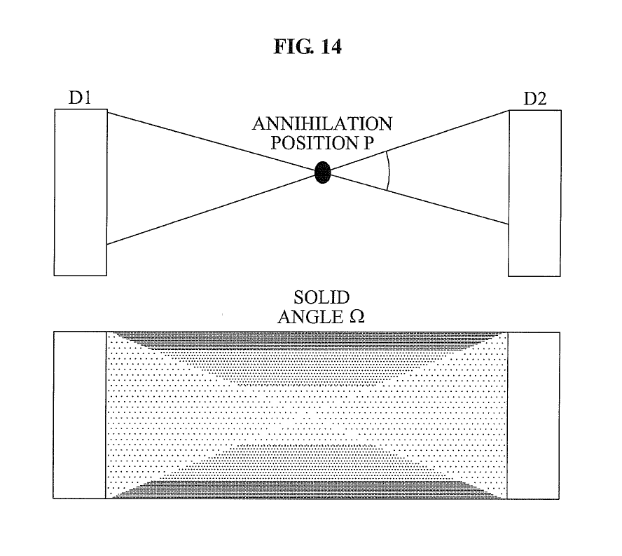

The parallax error may enable an object to be moved toward the center of the system to be blurred, and this phenomenon may intensify as the distance from the center of the system is increased. Also, another reason why the resolution in the PET may be variant may be a tangential blur. FIG. 14 is a diagram to describe a correlation between a size of a detector and a tangential blur.

D1 and D2 of FIG. 14 may indicate detectors, and each of the detectors may correspond to D1 and D2 illustrated in FIG. 13. When two gamma rays are irradiated from an annihilation position P, a probability that D1 and D2 may simultaneously measure the irradiated gamma rays respectively may be proportional to a solid angle.

Thus, solid angles with respect to each of D1 and D2 in a predetermined position between D1 and D2 may be described in FIG. 14.

A position in the middle of D1 and D2 may have narrow distribution of the solid angle. However, when the position is close to each of D1 and D2, the distribution of the solid angle may be widened. Accordingly, in the center of the system, the position may be estimated to be close to an actual position, only using projection information.

However, when the position is away from the center of the system, inaccuracy with respect to the position may become greater, an estimation of the position to be close to the actual position only using the projection information may be difficult. That is, when the position is away from the center of the system, resolution may become worse, and accordingly spatial imbalance of the resolution may occur.

To resolve these problem, the apparatus for generating the image may dispose a point source at every position of an HR image, and may obtain data with respect to each to position, thereby calculating blur kernels for each position, according to the fourth embodiment.

The apparatus for generating the image may use a Monte Carlo simulation, and in this instance, the point source may be disposed more accurately than before.

Also, when blur kernels for each position are calculated, the apparatus for generating the image may convert the blur kernels into an image through reconstruction. When the source is disposed in each pixel of an HR image, the apparatus for generating the image may consider characteristics of various blur phenomena such as a parallax error, a tangential blur problem caused by a size of a detector, and the like, using a point that how the source may be blurred may be understandable.

For example, each of the LR images may be generated when the HR image is blurred, and then the blurred HR image is down-sampling. However, the Monte Carlo simulation may measure the blur kernel using an LR spacing, rather than HR spacing.

Accordingly, the apparatus for generating the image may provide a function to complexly perform a blurring process and a down-sampling process in an SR scheme.

The apparatus for generating the image may convert an HR image into an LR image by burring and down-sampling the HR image. The apparatus for generating the image may compensate for a position correction problem of an object caused by a parallax error and a tangential blur problem caused by a size of the detector, using a blur kernel with respect to the LR that may be calculated using a Monte Carlo simulation.

The SR algorithm of the present invention may generally have an ill-posed problem. When a predetermined cost function, for example, a likelihood function with respect to Poisson, is maximized or minimized, various solutions that may have the same cost function may exist. In order to resolve the problem, the apparatus for improving resolution may provide regularization and may derive the unique solution through the regularization.

The apparatus for generating the image may use total-variation regularization that may have a characteristic of preserving an edge having a great gradient.

Also, the apparatus for generating the image may calculate a solution that may be limited to a positive number, by adjusting several parameters.

For example, according to a regularization characteristic that may be used in an MAP-EM, a solution corresponding to a negative number may be calculated, and thus, the apparatus for generating the image may limit the solution to be a value within a predetermined range or to correspond to a positive number, using the total-variation regularization.

The above-described method of improving resolution may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the to scope of which is defined by the claims and their equivalents.

What is claimed is:

1. An apparatus for improving resolution, the apparatus comprising:
a response ray detector to detect response rays in response to radioactive rays irradiated to a measurement target;
a sinogram extractor to extract sinograms from the detected response rays; and
a super-resolution converter to convert the extracted sinograms into high-resolution sinograms.

2. The apparatus of claim 1, wherein the high-resolution converter extracts, from the detected response rays, a plurality of sinograms, at least parts of which are overlapped, and converts the plurality of the extracted sinograms into high-resolution sinograms.

3. The apparatus of claim 2, wherein the high-resolution converter converts the plurality of the extracted sinograms into the high-resolution sinograms, using a super-resolution algorithm, or a maximum likelihood expectation maximization (MLEM) algorithm.

4. The apparatus of claim 1, wherein the extracted sinograms remain in a blur state by at least one factor among a positron range of the radioactive rays, non-colinearity of the radioactive rays, and a size of a detector.

5. The apparatus of claim 1, further comprising:
an image reconstruction processing unit to reconstruct a high-resolution image from the converted high-resolution sinograms,
wherein the image reconstruction processing unit uses at least one of a filtered back projection (FBP) algorithm, a back projection and filtering (BPF) algorithm, a total-variation regularization algorithm, an ordered-subset expectation maximization (OSEM) algorithm with respect to a Poisson distribution, and a maximum a priori expectation maximization (MAP-EM) algorithm with respect to a Poisson distribution.

6. The apparatus of claim 1, wherein the high-resolution converter estimates a blur kernel of a positron emission tomography (PET) image based on information that is measured in a PET detector, and converts the extracted sinograms into high-resolution sinograms using the measured blur kernel.

7. The apparatus of claim 1, wherein the high-resolution converter estimates the high-resolution sinograms, based on at least one of low-resolution sinograms that are measured in at least one wobble position, information indicating relationship between the high-resolution sinograms and the low-resolution sinograms, a noise component that enables the measured low-resolution sinograms to be a random vector having a Poisson distribution.

8. The apparatus of claim 7, wherein the high-resolution converter estimates the relationship between the high-resolution sinograms and the low-resolution sinograms, based on at least one of movement information of sinograms in at least one wobble position, information indicating down-sampling, information indicating a blur between the high-resolution sinograms and low-resolution sinograms.

9. The apparatus of claim 7, wherein, in a case of a spatially variant blur, the high-resolution converter estimates the relationship between the high-resolution sinograms and the low-resolution sinograms, based on information unitarily indicating blurring and down-sampling, and information indicating a motion in at least one wobble position.

10. The apparatus of claim 6, wherein the high-resolution converter selects data of positions corresponding to at least one angle from the extracted sinograms, using a Monte Carlo simulation, and estimates the blur kernel based on the selected data.

11. The apparatus of claim 6, wherein the high-resolution converter first calculates a part of a matrix indicating blurring and down-sampling with respect to at least one angle based on the extracted sinograms, and derives a remaining part of the matrix based on the calculated result.

12. An apparatus for generating an image, the apparatus comprising:
a signal classifier to classify, based on a position of a positron emission tomography (PET), input signals applied through a motion of an entire PET detector or a bed motion;
a first image generator to generate a first image set by reconstructing the classified input signals;
a parameter measurement unit to measure a point spread function (PSF) based on the first image set; and
a second image generator to generate second image information by applying a super-resolution algorithm based on the PSF.

13. The apparatus of claim 12, wherein:
the first image set corresponds to a set with respect to a low-resolution image, and
the second image information corresponds to information with respect to a high-resolution image.

14. The apparatus of claim 12, wherein the first image generator generates the first image set, using at least one of analytic reconstruction algorithms, and iterative reconstruction algorithms.

15. The apparatus of claim 12, wherein the second image generator generates the second image information using the PSF as a blur model.

16. The apparatus of claim 12, wherein the second image generator generates the second image information by applying, as the super-resolution algorithm, the following equation:
$${\hat{x}}^{n + 1} = {\hat{x}}^{n} + β [ {\sum }_{k = 1}^{p} {W}_{k}^{T} ( {y}_{k} - {W}_{k} {\hat{x}}^{n} ) - α {C}^{T} C {\hat{x}}^{n} ]$$
where yₖ corresponds to a first image set (1≦k≦p), p corresponds to a number of the first image set, \hat{X}ⁿ corresponds to n^{th} second image information, Wₖ corresponds to a matrix value comprising down-sampling, blurring, and translation, C corresponds to a high-pass filter value, α corresponds to a smoothness parameter, β corresponds to a convergence parameter, and T corresponds to a matrix transpose.

17. The apparatus of claim 12, wherein when a negative number is excluded from the first image set, the second image generator generates the second image information by applying a maximum likelihood expectation maximization (MLEM) algorithm of the following equation:
$${\hat{x}}^{n + 1} = {\hat{x}}^{n} \frac{{\sum }_{k = 1}^{p} {W}_{k}^{T} ( \frac{{y}_{k}}{{W}_{k} {\hat{x}}^{n}} )}{{\sum }_{k = 1}^{p} {W}_{k}^{T} 1 + λ \frac{\partial F ( {\hat{x}}^{n} )}{\partial x}}$$
where yₖ corresponds to a first image set (1≦k≦p), p corresponds to a number of the first image set, \hat{X}ⁿ corresponds to n^{th} second image information, Wₖ corresponds to a matrix value comprising down-sampling, blurring, and translation, T corresponds to a matrix transpose,
$$λ \frac{\partial F ( {\hat{x}}^{n} )}{\partial x}$$
corresponds to a regularization term using a total-variation, and λ corresponds to a regularization parameter, a value indicating a degree of regularization.

18. An apparatus for generating an image, the apparatus comprising:
a signal classifier to dispose a point source at each pixel position of a high-resolution image through a motion of an entire positron emission tomography (PET) detector or a bed motion, and to classify, based on a position of a PET, input signals applied through the motion;
a first image generator to generate a first image set by reconstructing the classified input signals;
a parameter measurement unit to measure a point spread function (PSF) based on the first image set; and
a second image generator to generate second image information by applying a super-resolution algorithm based on the PSF,
wherein the second image generator obtains data corresponding to the point source for the each pixel position, and to calculate a blur kernel for the each pixel position based on the obtained data, by applying the super-resolution algorithm.

19. The apparatus of claim 18, wherein the second image generator compensates for at least one of position correction problem of an object, caused by a parallax error in the second image information, and a tangential blur problem caused by a size of the detector, based on blur kernels of a low-resolution image that is converted by blurring a high-resolution image or down-sampling the high-resolution image, and a low-resolution image calculated using a Monte Carlo simulation.
